(19) United States
(12) Patent Application Publication
(10) Pub. No.: US 2016/0130843 A1
(43) Pub. Date: May 12, 2016

(54) LOW VOLTAGE BACKUP ASSEMBLY FOR ELECTRONIC LATCH

(71) Applicant: ADAC Plastics, Inc., Grand Rapids, MI (US)

(72) Inventors: Robert L. Bingle, Grand Rapids, MI (US); Charles Bruce Banter, Northville, MI (US); Marcus E. Merideth, Westland, MI (US)

(21) Appl. No.: 14/938,068

(22) Filed: Nov. 11, 2015

Related U.S. Application Data
(60) Provisional application No. 62/078,684, filed on Nov. 12, 2014.

(51) Int. Cl. E05B 81/76; E05B 1/00; E05B 81/56; E05C 3/12; E05B 85/26; E05B 85/28; E05B 81/68; E05C 3/14; E05B 85/10

(52) U.S. Cl. CPC E05B 81/76; E05C 3/14; E05B 1/0053; E05B 81/56; E05B 85/10; E05B 85/26; E05B 85/28; E05B 81/68; E05C 3/124

(57) ABSTRACT

A door handle and actuation assembly for opening a door of a vehicle includes a striker and a latch assembly. The latch assembly includes a latch biased to engage the striker to secure the vehicle door in a closed position. A first latch actuator is configured to receive an electronic signal for disengaging the latch from the striker. A second latch actuator is redundant to the first latch actuator and a power source is available for providing an electrical signal to the second latch actuator. The second latch actuator includes a shape memory alloy having a first configuration and a second configuration that different from the first configuration when subject to an electrical current. The second configuration is cooperable with the latch assembly for disengaging the latch from the striker.

### PRIOR APPLICATIONS

The present application claims priority to U.S. patent application Ser. No. 62/078,684, filed Nov. 12, 2014, the contents of which are included herein by reference.

### TECHNICAL FIELD

The present invention relates toward an electronic latch actuator for a vehicle door. More specifically, the present invention relates toward a low-voltage backup assembly for actuating an electronic latch using a secondary power source.

### BACKGROUND

Mechanical devices on vehicles are being replaced with electronic devices on an ever-increasing basis. One such example is replacement of mechanically-actuated latches used for opening doors, tailgates, and trunks of motor vehicles with electronic latches. Electronic latches use power from a primary vehicle power source such as, for example, a 12-volt vehicle battery for powering an integrated servo motor. Electronic latches typically include a latch (or pawl) that locks onto a striker to securely close a vehicle door. Presently, electronic latches are actuated by servomotors that require a significant amount of electrical energy to disengage the latch from the striker. However, this arrangement is ineffective if a vehicle battery loses power. In such instances, the servomotor, not having been powered, is incapable of disengaging the latch from the striker. The result is an inability to gain access to a vehicle interior when the vehicle battery has lost power. Additionally, redundant mechanically-actuated devices are typically required to actuate an interior door latch from the vehicle interior to prevent an occupant from being trapped in the interior upon loss of power to the vehicle battery.

To overcome a loss of primary battery power, super capacitors that retain an electrical charge are included providing energy to both a sensor disposed in a door handle and the servomotor used to disengage the latch from the striker to open a vehicle door. However, super capacitors are known to lose their charge at low temperatures such as, for example, negative 40° C., which is typical of northern climates. Additionally, super capacitors are known to be heavy. To provide sufficient power and low temperatures, multiple super capacitors have been employed to reach a voltage level necessary to operate the servo motors and gear train drives used in current latch assemblies. The use of a super capacitor with this design is not considered very functional. Therefore, an improved electronic latch assembly capable of operating at very low temperatures and low voltage for actuating a vehicle latch would be desirable.

### SUMMARY

A door handle and actuation assembly for opening a door of a vehicle includes a striker and latch assembly. A latch assembly includes a latch to engage the striker to secure the vehicle door in a closed position. The first latch actuator is configured to receive an electronic signal for disengaging the latch from the striker. A second latch actuator is redundant to the first latch actuator and a secondary power source is available for providing an electrical signal to the second latch actuator. The second latch actuator includes a shape memory alloy having a first configuration and a second configuration that is different from the first configuration when subject to an electrical current. The second configuration is cooperable with the latch assembly to disengage the latch from the striker. The shape memory alloy provides the ability to actuate a latch assembly with very low voltage, for example, three volts or less. This allows the ability to provide a secondary power source that is both compact and light, such as, for example, a lithium ion battery providing a secondary power for the secondary actuation assembly to open a vehicle door in the event insufficient power is provided to a servomotor from a main power source of the vehicle.

### BRIEF DESCRIPTION OF THE DRAWINGS

Other advantages of the present invention will be readily appreciated as the same become better understood by reference to the following detailed description when considered in connection with the accompanying drawings, wherein:

FIG. 1 shows an environmental view of a vehicle door actuation assembly disposed upon a vehicle;

FIG. 2 shows a schematic of the assembly of the present invention for actuating a door latch of a vehicle;

FIGS. 3A and 3B shows a shape memory alloy device;

FIG. 4 shows one embodiment of assembly of the present invention; and

FIGS. 5A-5D show an alternative embodiment for storing energy sufficient to actuate an electronic vehicle door latch without the use of a vehicle battery.

### DETAILED DESCRIPTION

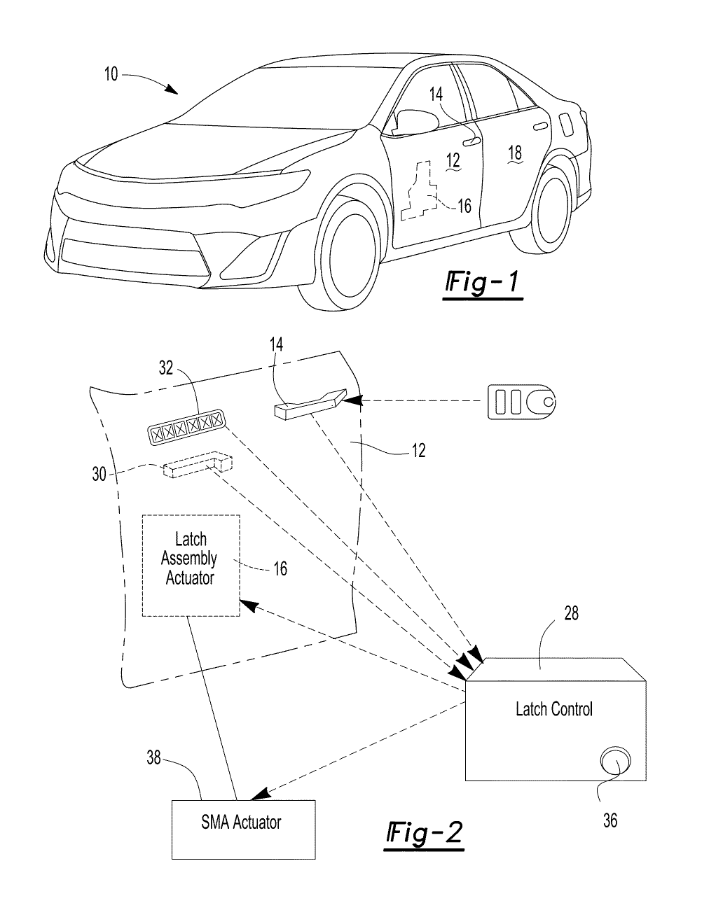

Referring to FIG. 1, a vehicle using the apparatus of the present invention is generally shown at 10. A front vehicle door 12 includes a door handle 14 and an actuation assembly 16 used to open and close the vehicle door 12 as will be explained further herein below. For simplicity, the actuation assembly 16 is shown only on the front vehicle door 12, but the actuation assembly may also be included on a rear vehicle door 18 and trunk or deck lid, (not shown) as desired.

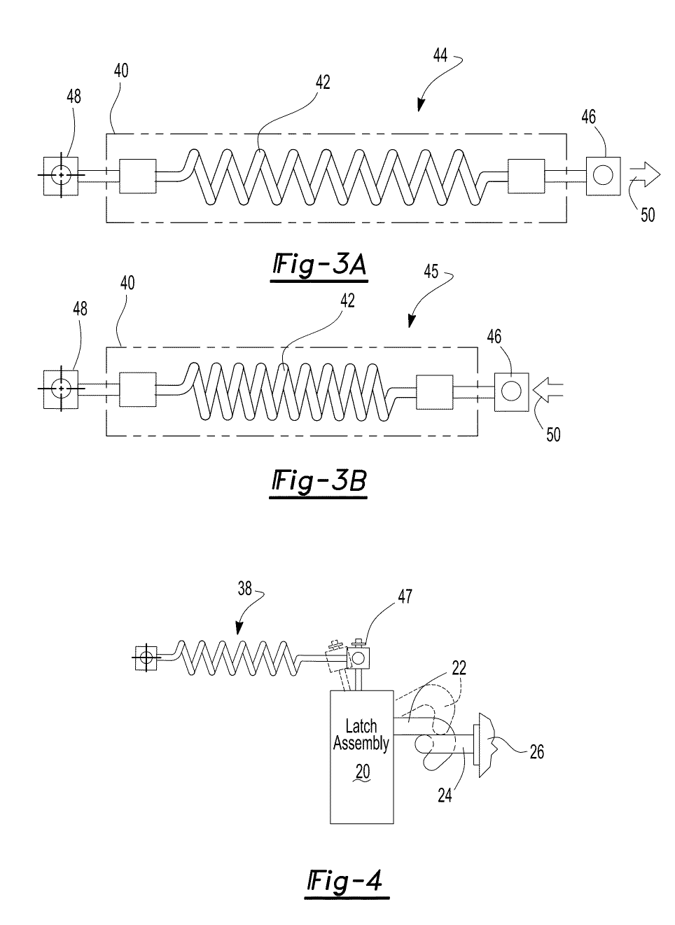

Referring now to FIG. 2, the latch actuator assembly 16 provides electronic actuation by way of a servomotor (not shown) or other electrical device. As best shown in FIG. 4, a latch assembly 20, which is included in the latch actuator assembly 16 disengages a pawl or latch 22 from a striker 24 when actuated by the servo motor. The striker is securely mounted on a pillar 26 of the vehicle 10 while the latch assembly 20 is securely mounted on the vehicle door 12, each in a known manner.

Referring again to FIG. 2, a latch control 28 sends an electronic signal to the latch assembly actuator 16 as represented by dashed lines used throughout FIG. 2. The latch control 28 signals the latch assembly actuator 16 to actuate the latch assembly 20 when receiving a signaled intent to actuate the latch assembly 20. The latch control 28 receives the signal from a variety of sources, including the exterior door handle 14, interior door handle 30, and a keypad 32. It should be understood that the exterior door handle 14, interior door handle 30 and keypad 32 are meant to be exemplary and not limiting. Other sources of a signal to the latch control 28 include, for example, a cellular phone (not shown), a remote cellular signal, a motion sensor, a proximity sensor, or any other electronic device capable of signaling the latch control 28. In addition, the interior door handle 30 may also include a mechanical link to the latch assembly actuator 16 to provide the method of mechanically actuating the latch assembly 20 in an emergency situation.

For security, a key FOB 34 optionally signals a receiver/transmitter (not shown) in the door handle 14 or other vehicle component that subsequently signals the latch control 28 authority to actuate the latch assembly 20. The latch control 28 will not signal the latch assembly 20 to actuate the latch 22 without also sensing a presence of a key FOB 34, or other security device to verify authorization to actuate the latch 22. Additionally, the key FOB 34 need not be present if an intent to actuate the latch 22 is signaled from the interior door handle 30.

A power source 36 secondary to a main vehicle battery (not shown) provides electrical energy to the latch control 28 and to a shape memory alloy actuator (SMA) 38. The secondary power source 36 is separate and independent of the primary vehicle battery and is capable of providing electric current to the latch control 28 and to the SMA actuator 38 when the main vehicle battery has lost its electrical charge. While the secondary power source 36 is contemplated to be a coin-type lithium ion battery, it can further take the form of conventional batteries, rechargeable batteries, small capacitors, or any other device capable of holding an electrical charge independent of the primary vehicle battery. It is further contemplated by the inventors that the secondary power source 36 is rechargeable when electric energy is received from the primary vehicle battery, an alternator, or in the event of an electric vehicle, when a charge is received while charging the vehicle batteries from an external source of electrical power.

The SMA actuator 38 includes an SMA device 40 as best represented in FIGS. 4A and 4B. The SMA device 40 includes a plastically-deformable alloy member 42 comprising a shape memory alloy, or equivalent disposed in a first configuration 44 generally shown in FIG. 4A. A first connector 46 securely engages a lever 47 or equivalent force transfer element of the latch 22 (shown in FIG. 4). A second connector 48 is fixedly attached in an immovable position relative to the latch 22 and first connector 46. Further, the second connector 48 is adapted to receive electrical current from the secondary power source 36, which is used to raise the temperature of the alloy member 42 causing plastic deformation of the alloy member 42 to a second configuration 45 as shown in FIG. 4B. FIG. 4B shows a contraction of the alloy member 42 causing the first connector 46 to move in the direction of arrow 50 translating mechanical motion to the latch 22 to disengage the striker 24.

It should be understood that when no electrical current is transferred to the alloy member 42 through the second connector 48, the alloy member 42 returns to ambient temperature causing the alloy member 42 to return to a first configuration shown at 44 from the second configuration shown at 60. The SMA actuator 38 is capable of generating sufficient force to disengage the latch 22 from the striker 24 with a minimal amount of electrical energy. For example, three volts or less received from the secondary power source 36 is capable of providing enough heat energy to the alloy member 42 to generate enough force to disengage the latch 22 from the striker 24. It should be further understood that alternative methods of raising the temperature of the alloy member 42 are within the scope of this invention and that the examples set forth above are merely exemplary and not limiting in nature.

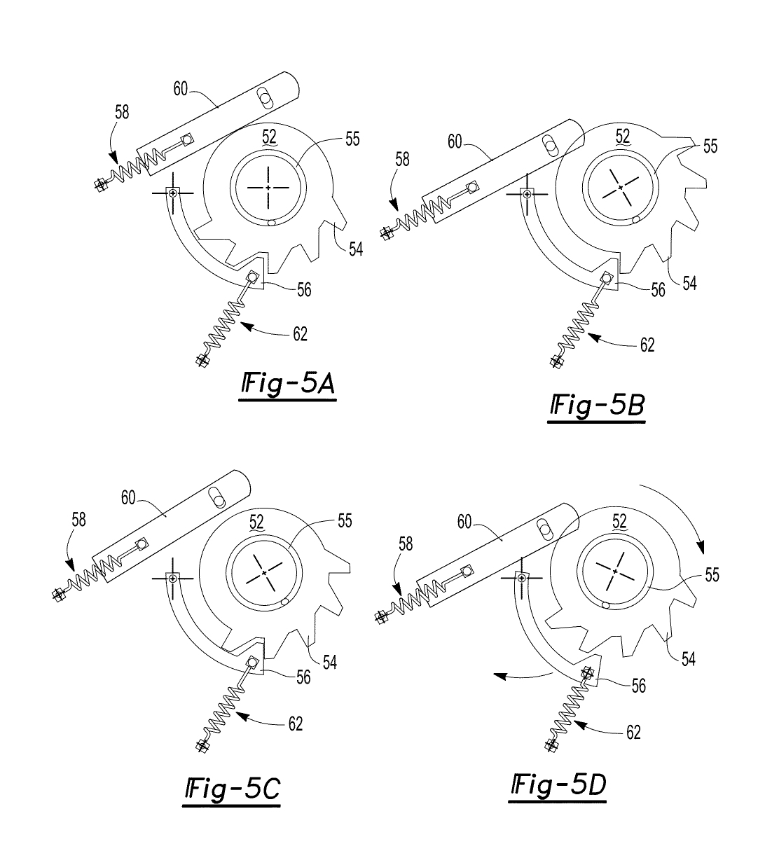

An alternative embodiment is shown in FIGS. 5A-5C where mechanical energy sufficient to disengage the latch 22 from the striker 24 is disclosed for further reducing the amount of electrical energy required to disengage the latch 22 from the striker 24. A rotary member 52 includes a plurality of ratchet teeth 54 that engage a pawl 56. The pawl 56 is biased to engage the ratchet teeth 54 to prevent the rotary member 52 from rotating in a clockwise direction as the ratchet member 52 is biased to do so. The bias is derived from a coil spring 58 or equivalent to rotate the rotary member 52 in the clockwise direction. A first SMA device 58 is fixedly attached to a translation arm 60 that translates counterclockwise motion to the rotary member 52 when electrical current is provided causing the first SMA device 58 to move from a first configuration 44 to a second configuration 48 as set forth above.

The first SMA device 58 is electrically linked to the vehicle car battery (not shown) or other source of electrical power to continuously receive enough electrical energy to maintain the first SMA device 58 in the second configuration 50. Therefore, when the vehicle battery loses power, the first SMA device 58 returns to the first configuration 44 enabling the rotary member 52 to rotate in a counterclockwise direction when not engaged with the pawl 56. Alternatively, electrical current is provided to the first SMA device 58 only a sufficient amount of time to translate the first SMA device 58 from the first configuration 44 to the second configuration 48 relying on the pawl 56 to maintain the rotary member 52 in a biased disposition. In this embodiment, the first SMA device 58 provides no additional force upon the rotary member 52 once it is rotated in a counter clockwise direction an amount sufficient to fully load the rotary member.

A second SMA device 62 is affixed to the pawl 56. The second SMA device 62 receives an electrical charge from the secondary power source 36 when signaled to do so by the latch control 28 as set forth above. Upon receiving the electrical charge from the secondary power source 36, the second SMA device contracts from the first configuration 44 to the second configuration 48 disengaging the pawl 56 from the ratchet teeth 54 of the rotary member 52 allowing the rotary member 52 to rotate in a clockwise direction thereby releasing the latch 22 from engagement with the striker 24. In this manner, even less force is required to be generated by the second SMA device 62 because the necessary mechanical energy to actuate the latch 22 has been translated to the coil spring 55 by the first SMA device 58 when receiving adequate electrical power from the primary vehicle battery. Therefore, only enough electrical energy to disengage the pawl 56 from the rotary member 52 is required.

The invention has been described in an illustrative manner, that is to be understood that the terminology that has been used is intended to be in the nature of words a description rather than that of limitation. Obviously, many modifications and variations of the present invention are possible in light of the above teachings. It is, therefore, to be understood that within this specification, the referenced numerals are merely for convenience, and are not to be in any way limiting. Therefore, the invention may be practiced otherwise and is specifically described throughout the specification.

What is claimed is:

1. A door handle and actuation assembly for opening a door of a vehicle, comprising:
a striker and a latch assembly including a latch biased to engage said striker to secure the vehicle door in a closed position;
a first latch actuator configured to receive an electronic signal for disengaging said latch from said striker;
a second latch actuator being redundant to said first latch actuator and a power source being available for providing an electrical signal to said second latch actuator; and
said second latch actuator including a shape memory alloy having first configuration and a second configuration being different from said first configuration when subject to an electrical current; with said second configuration being cooperable with said latch assembly for disengaging said latch from said striker.

2. The assembly set forth in claim 1, wherein said shape memory alloy includes a first length while disposed in said first configuration and a second length while disposed in said second configuration, said first length being shorter than said second length.

3. The assembly set forth in claim 1, wherein said second latch actuator includes a biasing device having a source of stored energy for disengaging said latch from said striker with said second latch actuator releasing the stored energy from said biasing device when said shape memory alloy is disposed in said second position.

4. The assembly set forth in claim 2, wherein said source of stored energy includes a torsional spring.

5. The assembly set forth in claim 4, wherein said torsional spring biases a gear and said gear transfers stored energy to said latch for disengaging said latch from said striker.

6. The assembly set forth in claim 5, wherein said second latch actuator includes a pawl being in locking engagement with said gear and said shape memory alloy disengages said pawl from said gear when said shape memory alloy is disposed in said second configuration.

7. The assembly set forth in claim 6, further including a second shape memory alloy being engageable with said gear for applying biasing force to said gear.

8. The assembly set forth in claim 1, wherein said power source comprises at least one of a battery or a capacitor.

9. The assembly set forth in claim 1, further including a latch controller adapted to receive a signal indicative of an intent to disengage said latch from said striker when the vehicle has lost primary power.

10. The assembly set forth in claim 1, wherein said latch controller receives electrical power from said power source sufficient in receive a signal indicative of an intent to disengage said latch from said striker.

11. An electronic door handle and actuator assembly for opening a door of a vehicle when a main power source of the vehicle has failed, comprising:
a striker and a latch assembly including a latch biased to engage said striker to secure the vehicle door in a closed position;
an electronic latch controller and a secondary power source for providing electric power to said latch controller;
a signal device for providing an electronic signal to said electronic latch controller indicative of an intent to actuate said latch thereby disengaging said latch from said striker; and
said actuator assembly including a first electronic latch actuator powered by the primary power source of the vehicle and a second electronic latch actuator including a shape memory alloy element capable of actuating said latch when the main power source of the vehicle has failed thereby disengaging said latch from said striker upon receiving electric power from said secondary power source.

12. The assembly set forth in claim 11, wherein said second electronic latch actuator includes a biasing member secured in a biased disposition and said shape memory alloy element including a first shape memory alloy device being retractable upon receiving electrical power thereby releasing said biasing member to actuate said latch.

13. The assembly set forth in claim 12, wherein said biasing member is secured in a biased disposition by a pawl releasably engaged with said biasing member and said pawl is interconnected with said shape memory alloy device for withdrawing said pawl from engagement with said biasing member thereby allowing said biasing member to actuate said latch.

14. The assembly set forth in claim 12, wherein said shape metal alloy element includes a second shape memory alloy device for providing a biasing a force to said biasing member.

15. The assembly set forth in claim 14, wherein said second shape memory alloy device receives electrical power from a primary vehicle battery for applying a biasing force upon said biasing member when said translating from first configuration to a second configuration.

16. The assembly set forth in claim 15, wherein said biasing force of said biasing member is stored in coil spring and said biasing force is retained in said biasing member by said pawl.

17. The assembly set forth in claim 11, wherein said second electronic latch actuator is cooperable with said first electronic latch actuator for assisting said first electronic latch actuator with actuating said latch when an insufficient amount of electrical energy is provided by the primary vehicle battery to actuate the latch.

18. The assembly set forth in claim 11, wherein said secondary power source comprises at least one of a lithium ion battery, a capacitor, or a combination thereof.

19. The assembly set forth in claim 1, wherein said secondary power source provides power to electronic latch controller sufficient for receiving a signal indicative of an intent to actuate said latch and provides power to said second electronic latch actuator for actuating said latch.

20. The assembly set forth in claim 11, wherein said second electronic latch actuator receives power from said secondary power source only if authorization is signaled to said electronic latch controller.
